(19) United States
(12) Patent Application Publication
(10) Pub. No.: US 2026/0278618 A1
(43) Pub. Date: Sep. 17, 2026

(54) DIALOG RESPONSE MANAGEMENT APPARATUS, NON-TRANSITORY COMPUTER READABLE MEDIUM FOR DIALOG RESPONSE MANAGEMENT PROGRAM, AND DIALOG SYSTEM

(71) Applicant: Honda Motor Co., Ltd., Tokyo (JP)

(72) Inventors: Kazuki Yoshigai, Tokyo (JP); Tameaki Honda, Tokyo (JP); Hiroshi Honda, Tokyo (JP)

(21) Appl. No.: 19/567,096

(22) Filed: Mar. 14, 2026

(30) Foreign Application Priority Data
Mar. 17, 2025 (JP) 2025-042717

(51) Int. Cl. G06Q 30/015; B60K 35/10; B60K 35/29; G06F 16/332; G06F 16/3329

(52) U.S. Cl. CPC G06Q 30/015; B60K 35/10; B60K 35/29; G06F 16/3322; G06F 16/33295

(57) ABSTRACT

A dialog response management apparatus configured to manage a response operation of sending answer information corresponding to question information issued from a user to the user, includes: a microprocessor; and a memory connected to the microprocessor. The microprocessor is configured to perform: receiving input of the question information created at a user terminal based on operation by the user and sent from the user terminal; analyzing either or both of an input operation process of the question information by the user and content of the question information; evaluating a question difficulty level, the question difficulty level being a degree of difficulty when the user creates the question information; and changing a response to the user according to a result of the evaluating.

### CROSS-REFERENCE TO RELATED APPLICATION

This application is based upon and claims the benefit of priority from Japanese Patent Application No. 2025-042717 filed on Mar. 17, 2025, the content of which is incorporated herein by reference.

### BACKGROUND

### Technical Field

The present disclosure relates to a technology for communicating with customers using text, audio, video, etc. over a computer network and responding to questions received by the customers.

### Related Art

A device that responds to a question sent from a customer using a chatbot or a manned chat system is known. JP 2024-141470 A discloses a device in which a chatbot device recognizes an inquiry content from a user, and switches an inquiry response from an automatic response to a manned response by a chatbot system in a case where the inquiry includes specific content.

In order for the user to master the chatbot and obtain accurate information, a certain degree of skill is required. An unfamiliar user may worry about how to ask a question and correct the input for the question many times. As a result, many trials and errors are repeated to obtain necessary information, and the customer may be dissatisfied, leading to a decrease in customer satisfaction.

### SUMMARY

An aspect of the present invention is a dialog response management apparatus configured to manage a response operation of sending answer information corresponding to question information issued from a user to the user, including: a microprocessor; and a memory connected to the microprocessor. The microprocessor is configured to perform: receiving input of the question information created at a user terminal based on operation by the user and sent from the user terminal; analyzing either or both of an input operation process of the question information by the user and content of the question information; evaluating a question difficulty level, the question difficulty level being a degree of difficulty when the user creates the question information; and changing a response to the user according to a result of the evaluating.

Another aspect of the present invention is a computer-readable storage medium storing a dialog response management program for causing a computer including a processor and a memory to execute. The dialog response management program causes the computer to perform: receiving input of the question information created at the user terminal based on operation by the user and sent from the user terminal, analyzing either or both of an input operation process of the question information by the user and content of the question information, and evaluating a question difficulty level, the question difficulty level being a degree of difficulty when the user creates the question information, and changing a response to the user according to a result of the evaluating.

Still another aspect of the present invention is a dialog system including: a user terminal operated by a user; and a dialog response management apparatus configured to manage a response operation of sending answer information corresponding to question information issued from the user terminal toward the user terminal. The dialog response management apparatus comprises a microprocessor and a memory connected to the microprocessor. The microprocessor is configured to perform: receiving input of the question information created at the user terminal based on operation by the user and sent from the user terminal; analyzing either or both of an input operation process of the question information by the user and content of the question information; evaluating a question difficulty level that is a degree of difficulty when the user creates the question information; and changing a response to the user according to a result of the evaluating.

### BRIEF DESCRIPTION OF THE DRAWINGS

The objects, features, and advantages of the present invention will become clearer from the following description of embodiments in relation to the attached drawings, in which:

FIG. 1 is a conceptual diagram illustrating a schematic configuration of a dialog system;

FIG. 2 is a block diagram illustrating functional blocks of a server constituting the dialogue system and components connected to the server via a network;

FIG. 3 is a flowchart for explaining a schematic processing procedure of a dialog processing executed by a CPU of the server; and

FIG. 4 is a flowchart for explaining another example of a schematic processing procedure of the dialog processing executed by the CPU of the server.

### DETAILED DESCRIPTION

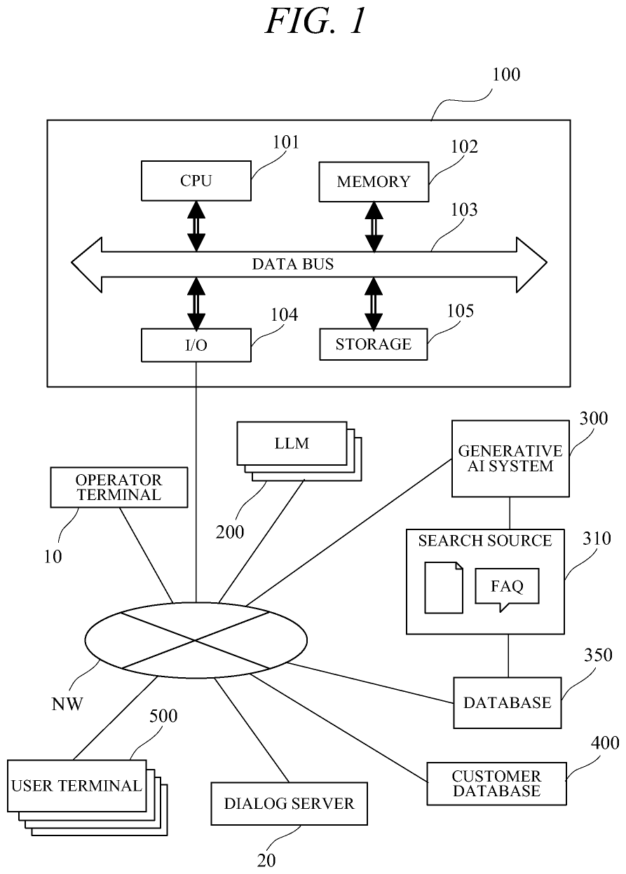

Hereinafter, an embodiment of the present disclosure will be described with reference to FIGS. 1 to 4. In all the drawings described below, common components are denoted by the same reference numerals, and repeated description is omitted. Note that not all the components shown in the following embodiments are essential components of the present disclosure.

FIG. 1 is a conceptual diagram illustrating a schematic configuration of an online chat system (dialog system). In the present embodiment, the dialog system can be a system that responds to a question (query) from the user regarding an automobile manufactured, sold, or the like by the company itself, or a service related to the automobile, as an example.

A server 100 is connected to an operator terminal 10, a dialog server 20, an LLM 200, a generative AI system 300, a database 350, a customer database 400, and a user terminal 500 via a network NW. In the present embodiment, various use forms of the dialog system can be provided to the user. For example, in a case where an unmanned dialog service is provided, the user terminal 500 is connected to the dialog server 20. At that time, the user terminal 500 and the dialog server 20 are connected via the server 100. Furthermore, in a case where the user terminal 500 and the operator terminal 10 operated by the chat operator are connected and a manned dialog service is provided, the user terminal 500 and the operator terminal 10 are connected via the server 100.

The server 100 includes a CPU 101, a memory 102, an I/O 104, a storage 105, and a data bus 103 that enables data exchange between these elements.

When providing the online chat service to the user, the server 100 analyzes the query and manages the response to the query as described below. The program for analyzing the query and managing the response may be stored in, for example, the storage 105, read from the storage 105 when the server 100 is activated, loaded into the memory 102, and executed by the CPU 101. Alternatively, the memory 102 may include a ROM, a flash memory, or the like, and a chatbot program stored in the ROM or the flash memory may be loaded into the memory 102 and executed by the CPU 101. In addition, a program obtained by being read from an optical disk drive device or a card reader (not illustrated) or being downloaded via the network NW may be loaded into the memory 102 and executed by the CPU 101. Hereinafter, the above-described query analysis and response management executed by the CPU 101 of the server 100 is referred to as dialog response management.

Note that the server 100 can be virtually realized by providing all or a part of each hardware configuration in a distributed manner in a plurality of computers and connecting them to each other via the network NW or the like. That is, the server 100 is a concept including not only a server housed in a single housing or case but also a virtualized computer system. Furthermore, the server 100 may be included in the dialog server 20, or conversely, the dialog server 20 may be included in the server 100.

In a case where a manned chat (live chat) is performed as the online chat, the operator terminal 10 operated by a chat operator (hereinafter, simply referred to as an operator) is connected to each of the server 100, the LLM 200, the generative AI system 300, the database 350, the customer database 400, and the user terminal 500 via the network NW. Furthermore, in a case where an unmanned chatbot service is provided, the dialog server 20 is connected to each of the server 100, the LLM 200, the generative AI system 300, the database 350, the customer database 400, and the user terminal 500 via the network NW.

The LLM 200 can be, for example, an LLM provided by a third party. The LLM (Large Language Model) is a large scale artificial intelligence model constructed by using a large set of text data and deep learning technologies, and used in the field of natural language processing (NLP). The LLM can learn a large amount of text data (web pages, books, articles, and the like) to understand patterns of languages used by humans and effectively perform natural language generation (NLG) tasks.

Note that, regarding the LLM 200 described above, other natural language processing including a small language model (SLM) may be used depending on the performance required for a manned chat.

The generative AI system 300 is a system having a function similar to that of the LLM 200 described above, but is also configured to be able to generate a voice or an image. When the server 100 needs to send voice or image information to the user terminal 500 in performing the dialog response management, the generative AI system 300 can be used differently. As the generative AI system 300, it is also possible to construct an own system, but other external services utilizing AI, such as ChatGPT, Google Gemini (registered trademark), Cerence (registered trademark), or Claude3 (registered trademark), may be used.

The database 350 can access a search source 310 in which questions, answers, and the like previously exchanged are stored to search for information.

In FIG. 1, an example in which a common search source 310 is connected to the generative AI system 300 and the database 350 is illustrated, but independent search sources may be connected individually. The search source 310 may be connected to the generative AI system 300 or the database 350 via the network NW. Furthermore, each of the generative AI system 300 and the database 350 may be configured to be able to access Web information and SNS information via the network NW.

In addition, a company, an organization, a group, or the like that provides the chat service may manage any or all of the LLM 200, the SLM, and the generative AI system 300. Similarly, the companies, organizations, groups, and the like may manage the search sources 310. As a result, for example, in a case where the chat system is operated by a company that manufactures or sells a vehicle or a contractor thereof, it is possible to make a more detailed and specific response.

As an example, regarding a question sent from the user who is driving the company-provided vehicle, not only outputting a general answer is possible, but also it is possible to make a more specific response such as “Please press the switch with a green design on the lower left among the plurality of steering switches provided on the right steering spoke”.

In addition, when receiving a question about a product such as a vehicle provided by the company or a service of an electronic commerce (EC) site or the like which is a website that sells a product or a service on the Internet, it is possible to output more detailed and diverse information to the user.

Furthermore, since the system is an own system, it is advantageous in that an increase in cost can be suppressed even in a case where transactions with the LLM 200, the generative AI system 300, and the database 350 to be used increase when a chat session is executed.

The customer database 400 is a database in which login information such as a password is accumulated in association with a user ID input when the user logs in to the chat service.

The user terminal 500 is an information processing apparatus operated by a user who uses the chat service. For example, a smartphone, a tablet terminal, a personal digital assistant (PDA), a personal computer, or the like can be used as the user terminal 500. Furthermore, as the user terminal 500, a mobile terminal device mounted on a vehicle such as a passenger car or a cargo vehicle, which is an in-vehicle infotainment (IVI) device connected to the network NW via a wireless communication network, can be used.

The network NW can use the Internet. Note that the generative AI system 300, the customer database 400, and the server 100 may be connected via a closed network service not via the Internet, or may be connected using a VPN technology. Alternatively, the generative AI system 300 and the customer database 400 may be included in the server 100. It is desirable to protect the customer database 400 using a strong encryption technology in order to enhance information security.

The user who receives the manned chat service with the operator operates the user terminal 500 and is connected to the operator terminal 10 operated by the operator. Then, a login and authentication procedure is performed to open a session of the chat service. Thereafter, the question information is transmitted from the user terminal 500 to the operator terminal 10. The responsible answer made between the user and the operator may be a response using characters, a response using sound, or a response using video and sound. When this question information is received by the operator terminal 10, the server 100 is interposed between the user terminal 500 and the operator terminal 10, and dialog response management described in detail below is performed.

A user who receives an unattended chat service such as a chatbot operates the user terminal 500 and is connected to the dialog server 20. Then, a login and authentication procedure is performed to open a session of the chat service. Thereafter, the question information is transmitted from the user terminal 500 to the dialog server 20. The responsible answer made between the user and the dialog server 20 may be a response using characters, a response using sound, or a response using video and sound. When this question information is received by the operator terminal 10, the server 100 is interposed between the user terminal 500 and the dialog server 20, and dialog response management described in detail below is performed.

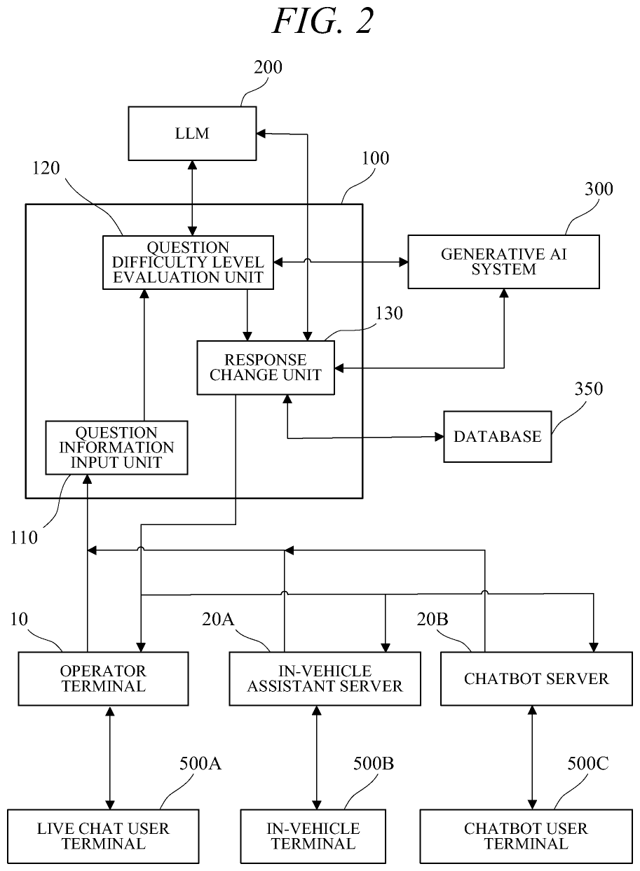

FIG. 2 is a block diagram illustrating a schematic configuration of the dialog system according to the embodiment of the present invention. When the CPU 101 executes the dialog response management program, the server 100 functions as a dialog response management apparatus. Although a live chat user terminal 500A, an in-vehicle terminal 500B, and a chatbot user terminal 500C are illustrated as examples of the user terminal operated by the user, all of these terminals may be included as the dialog system, or any one or two of these terminals may be included. In addition, other types of terminals may be included.

The live chat user terminal 500A is used when the user and the operator perform live chat by voice, and is connected to the operator terminal 10 operated by the operator. As the live chat user terminal 500A, a smartphone, a tablet terminal, a personal computer, or the like can be used. The user can exchange (transmission of question information, reception of answer information, and the like) with the operator in the form of live chat via the live chat user terminal 500A and the operator terminal 10. Alternatively, the user can input text by operating a display with a touch panel included in the live chat user terminal 500A, and send the question information to the operator terminal 10. Furthermore, when the user utters a voice toward the live chat user terminal 500A, the voice is converted into text information by voice recognition and sent to the operator terminal 10 as question information.

The in-vehicle terminal 500B is implemented as a terminal that realizes at least a part of the functions in the IVI mounted on the vehicle used by the user, and is connected to an in-vehicle assistant server 20A. The user can operate the display with the touch panel included in the in-vehicle terminal 500B to input text and send the question information to the in-vehicle assistant server 20A. Alternatively, when the user utters the voice toward the in-vehicle terminal 500B, the voice is converted into text information by voice recognition and sent to the in-vehicle assistant server 20A as question information.

As the chatbot user terminal 500C, a smartphone, a tablet terminal, a personal computer, or the like can be used. The user can send question information input as text by operating a display with a touch panel, a keyboard, or the like to a chatbot server 20B. Alternatively, the user utters the question information to the chatbot user terminal 500C, and the question information is converted into the text information by the voice recognition and is sent to the chatbot server 20B.

The server 100 as a dialog response management apparatus includes a question information input unit 110, a question difficulty level evaluation unit 120, and a response change unit 130. The user starts a dialog session with the corresponding operator terminal 10, the in-vehicle assistant server 20A, or the chatbot server 20B by using any one of the live chat user terminal 500A, the in-vehicle terminal 500B, and the chatbot user terminal 500C. Then, when the question information is transmitted from the terminal side as described above, the question information input unit 110 temporarily stores information indicating an input operation procedure of the question information by the user. The question information input unit 110 can also temporarily store the question information itself in addition to the information indicating the input operation procedure described above. Hereinafter, the question information and the information indicating the input operation procedure of the question information are referred to as question difficulty level evaluation information. The question difficulty level evaluation information may include any one of information indicating an input operation procedure of the question information and the question information.

The question information input unit 110 sends the question difficulty level evaluation information to the question difficulty level evaluation unit 120. When the question difficulty level evaluation information sent from the question information input unit 110 is text information, the question difficulty level evaluation unit 120 outputs the question difficulty level evaluation information to the LLM 200, generates a prompt for evaluating the question difficulty level of the user based on the question difficulty level evaluation information, and sends the prompt to the LLM 200. In a case where the question difficulty level evaluation information is voice information or the like, the question difficulty level evaluation unit 120 outputs the question difficulty level evaluation information to the generative AI system 300, generates a prompt for evaluating the question difficulty level of the user based on the question difficulty level evaluation information, and sends the prompt to the generative AI system 300.

When the user asks a question using the dialog system, the user may not know how to ask a question. In such a case, the user may stagnate or rephrase if the question is based on utterance. In addition, interjections such as “a” and “um” are often used. When speaking, the intonation may be weak and unconfident. In addition, it may take time from the start of the question to the completion of the question. If the question is by key input (text), the input may be modified many times when the question is difficult for the user. In addition, when inputting a sentence, the user may be confused for a while, and the input may not start. By accurately detecting the above event seen in the process of the input operation of the question sentence when the question is difficult using AI in a short time and evaluating the difficulty level of the question, it is possible to provide more careful support to the user who is worried about the way of the question, which is different from a normal response.

Note that it is also possible to detect the difficulty level of the question from the input question information itself. For example, if the user repeatedly utters a question in an opened dialog session, there is a possibility that the user feels that the purpose of the question uttered by the user is not well conveyed and the user finds it difficult to ask a question. By evaluating the difficulty level of the question using AI based on the similarity and the relevance of the repeatedly input question information, it is possible to accurately support the user who repeats the question of the same purpose while changing the expression. Furthermore, if contents that can be expressed in one word by using technical terms are expressed in long sentences, it can be estimated that knowledge in the relevant field is not sufficient and the user finds it difficult to ask a question. Note that the similarity of the question information is determined by converting each of the two pieces of input question information into numerical data (for example, the embedding vector) and comparing the numerical data. When the similarity calculated as a result of the comparison is a predetermined threshold or more, it is determined that the similarity of the mutual question information is high. The relevance is determined in a similar manner. Based on the above points, the question difficulty level evaluation unit 120 and the response change unit 130 are configured as follows.

The question difficulty level evaluation unit 120 issues a response command to the response change unit 130 based on the evaluation result of the question difficulty level output from the LLM 200 or the generative AI system 300. Based on the response command output from the question difficulty level evaluation unit 120, the response change unit 130 can make a response exemplified below to the user via the operator terminal 10, the in-vehicle assistant server 20A, or the chatbot server 20B corresponding to any one of the live chat user terminal 500A, the in-vehicle terminal 500B, or the chatbot user terminal 500C used by the user for dialog.

The response change unit 130 can ask the user a question such as “Are you in trouble?”. By making such an inquiry, the cause of the question difficulty level felt by the user can be estimated based on the answer obtained from the user, and more accurate support can be provided. Furthermore, the response change unit 130 can send answer information using plain terms to the user who has asked a long question by combining general terms without using technical terms.

The response change unit 130 can further access the database 350 to search for information having a high similarity or a high relevance with the question uttered by the user from information (past QA information) of the past exchanges (questions and responses). In the past QA information, information based on not only the currently responding user but also the responsible answer made with another user is accumulated. Then, a question candidate is indicated to the user based on the search result. If there is one question candidate, the user can be guided to respond yes/no, and if there are multiple question candidates, the user can be guided to select one of them. At this time, by presenting question candidates to the user in descending order of similarity to the question uttered by the user or in descending order of relevance based on the search result, the user can easily find the target question.

Note that the response change unit 130 can also issue a prompt to the LLM 200 or the generative AI system 300 to obtain information having high similarity or high relevance with the question uttered by the user. At that time, in a case where the question candidate to be presented to the user is by voice or image, the generative AI system 300 may be accessed, and in a case where the question candidate is by character information, the LLM 200 or the generative AI system 300 may be accessed.

The response change unit 130 can further suggest the user to switch to the response by the manned operator according to the evaluation result of the question difficulty level acquired from the question difficulty level evaluation unit 120. For example, the question difficulty level evaluation unit 120 can also evaluate the movement of emotions such as irritation and sense of urgency based on the content and tone of a voice question uttered by the user, the content of a text question, and the like. The response change unit 130 makes a proposal to switch to the response by the manned operator according to the evaluation result of the question difficulty level and the emotion movement, so that it is possible to quickly provide the response by the manned operator to the user when the user's frustration increases or the user is in an urgent situation.

In addition to the response described above, the response change unit 130 outputs a prompt corresponding to the question sent from the user to the LLM 200 or the generative AI system 300, or accesses the database 350 and outputs a search command, thereby obtaining an answer (search result) from these information sources. The response change unit 130 prepares answer information to be transmitted to the user based on the answer (hereinafter, it is referred to as original answer) obtained from the information source. The response change unit 130 sends the answer information to any of the terminals 500A, 500B, and 500C used by the user via the operator terminal 10, the in-vehicle assistant server 20A, and the chatbot server 20B in which a dialog session with the terminal is opened.

Note that, in the above description, in a case where the user is interacting with a manned operator via the live chat user terminal 500A, the response change unit 130 does not send a proposal for switching to a response by the manned operator. For other responses, when the user and the operator are interacting with each other, an instruction to change the response to the user may be displayed on the operator terminal 10, or a voice generated by AI may be sent to the live chat user terminal 500A by interrupting the dialog between the user and the operator.

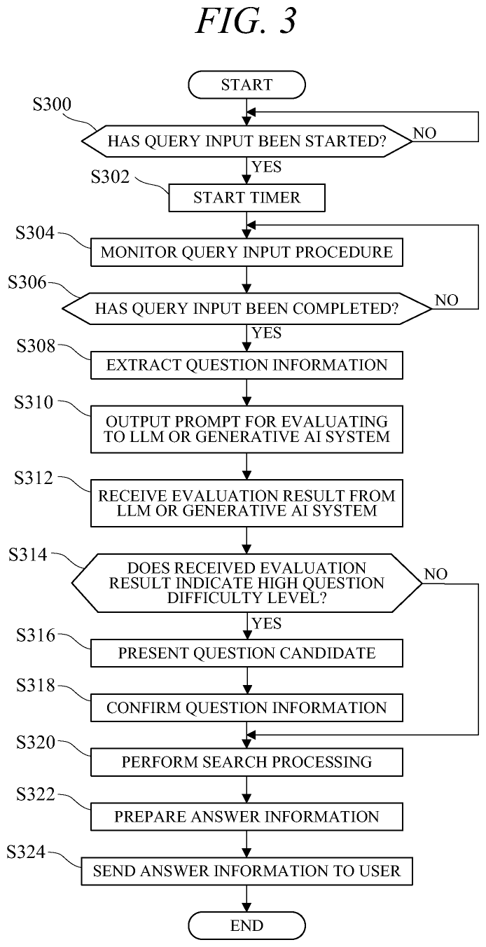

FIG. 3 is a flowchart for explaining a schematic processing procedure of the dialog response management executed by the CPU 101 of the server 100. The processing illustrated in FIG. 3 is executed when a dialog session is started between any one of the live chat user terminal 500A, the in-vehicle terminal 500B, and the chatbot user terminal 500C used by the user and any one of the corresponding operator terminal 10, the in-vehicle assistant server 20A, and the chatbot server 20B. Hereinafter, for the sake of easy understanding, when it is not necessary to distinguish and describe the live chat user terminal 500A, the in-vehicle terminal 500B, and the chatbot user terminal 500C used by the user, they are simply referred to as user terminals. Similarly, when it is not necessary to distinguish and describe the operator terminal 10, the in-vehicle assistant server 20A, and the chatbot server 20B, they are simply referred to as response apparatuses.

In S300, the CPU 101 determines the presence or absence of the start of the query input from the user terminal, and waits for the start of the query input in S300 while the determination result is negative. When the determination in S300 is affirmative, the process proceeds to S302, and the timer is initialized and then started. This timer is for measuring an elapsed time from when the user starts a query input operation via the user terminal.

In S304, the CPU 101 monitors the query input procedure by the user. That is, the CPU 101 monitors a process in which the user operates the user terminal and utters an utterance or a character input operation to issue a question to the response apparatus. In a case where the question is input by utterance, the utterance content is analyzed, and the presence or absence of hesitation or restatement, and the type and number of interjection are sequentially counted. In a case where the input of the question is based on text, a character correction history and a length of a blank period of an operation from an operation of inputting one sentence to an operation of inputting the next sentence are detected and recorded.

In S306, the CPU 101 determines whether the query input by the user has been completed, and while this determination is negative, the processing of S304 is continuously performed. When the determination in S306 is affirmative, the process proceeds to S308, and the CPU 101 stops the timer started in S302 and determines the time from the start to the completion of the query input. Then, the CPU 101 extracts question information to be output as a prompt to the LLM 200 or the generative AI system 300 based on the question input by the user.

In S310, the CPU 101 outputs the entire or part of the question content from the user obtained as a result of monitoring the query input procedure in S304 to the LLM 200 or the generative AI system 300, and outputs a prompt for evaluating the question difficulty level of the user. At this time, the CPU 101 outputs utterance content to the generative AI system 300 in a case where the question from the user is an utterance, and outputs a prompt to evaluate the question difficulty level based on tone, intonation, and the like. Furthermore, in a case where the question from the user is by character input, the CPU 101 outputs the content of the question input by the user to the LLM 200 or the generative AI system 300, and outputs a prompt to evaluate the question difficulty level based on how the technical term is used and the similarity or relevance with the question input by the user at another timing during the same session.

In the LLM 200 or the generative AI system 300, when the question information is input a plurality of times in the same session, similarity between the question information is determined, and when there is question information with high similarity, it is evaluated that the question difficulty level is high. Note that, in a case where the time until the question information is confirmed exceeds a predetermined time, it may be evaluated that the question difficulty level is high. Furthermore, in a case where the user performs an input operation of question information by utterance, the question difficulty level may be evaluated to be high when the user's hesitation or restatement exceeding a predetermined number of times is detected. Furthermore, in a case where the user performs an input operation of question information by character input, when a history of character correction exceeding a predetermined number of times is detected during the character input operation of the user, the question difficulty level may be evaluated to be high.

In S312, the CPU 101 receives the evaluation result of the question difficulty level from the LLM 200 or the generative AI system 300, and determines in S314 whether the received evaluation result indicate a question difficulty level is high. When the determination in S314 is affirmative, the CPU 101 sends information to the response apparatus so that the question candidate is presented to the user terminal in S316. That is, the CPU 101 extracts question information having a high similarity or relevance to the question information extracted in S308 from the question uttered by the user who has used the dialog system in the past, recorded in the database 350, and sends the information to the response apparatus so that a question candidate is presented to the user terminal. The user selects a question that follows his/her idea from among question candidates presented on the user terminal operated by the user. The selection result is transmitted from the user terminal to the server 100 via the response apparatus, and the CPU 101 confirms the question information in S318. In a case where the determination in S314 is negative, the process proceeds to S320.

In S320, the CPU 101 performs search processing based on the question information extracted in S308 or the question information defined in S318. Specifically, based on the question information, the CPU 101 generates a prompt and outputs the prompt to the LLM 200 or the generative AI system 300. Then, answer information including the original answer which is the answer output from the LLM 200 or the generative AI system 300 is received. Alternatively, the CPU 101 sends a search command to the database 350 in response to the question information. Then, answer information including the original answer is received from the database 350.

In S322, the CPU 101 prepares answer information to be transmitted to the user terminal based on the answer information received in S320. Alternatively, the CPU 101 may not prepare the answer information, the CPU 101 may send the original answer to the response apparatus, and the response apparatus that has received the original answer may prepare the answer information.

In S324, the CPU 101 performs processing of sending the answer information to the user terminal. Specifically, in a case where the CPU 101 prepares the answer information as described above, the answer information is transmitted to the response apparatus, and a command to transmit the answer information to the user terminal is issued to the response apparatus. Alternatively, in a case where the response apparatus prepares the answer information, a command is issued to the response apparatus so as to transmit the answer information to the user terminal.

The dialog response management processing in S300 to S324 described above is repeatedly executed until the dialog session opened once is opened and the user performs the dialog session closing operation.

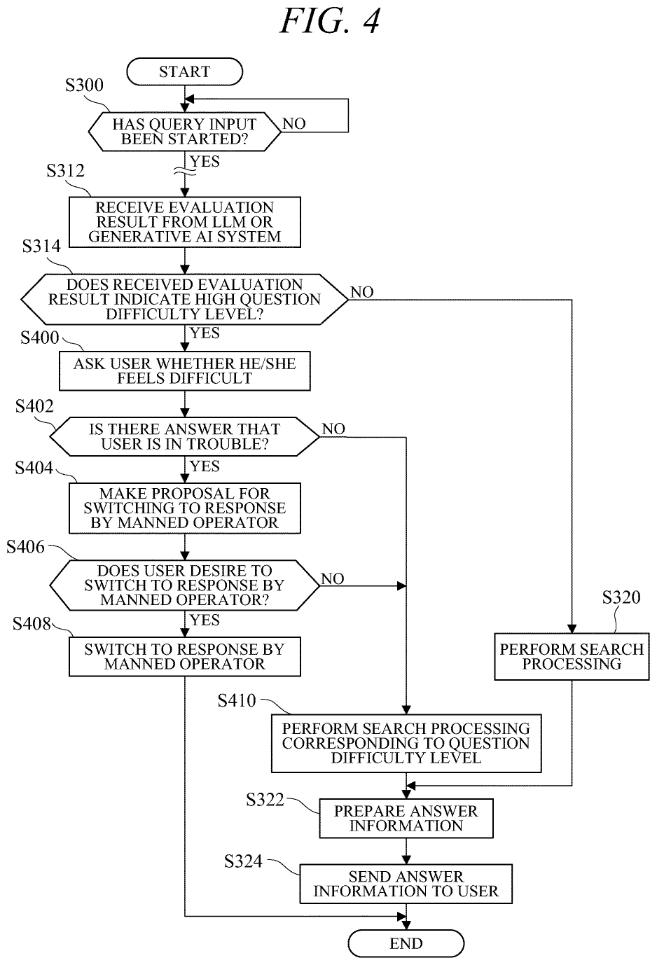

FIG. 4 is a schematic flowchart for explaining another example of the dialog response management processing executed by the CPU 101. The processes of FIG. 4 are executed subsequent to the process of S310 illustrated in the flowchart of FIG. 3. In the flowchart of FIG. 4, the same processes as those in the flowchart illustrated in FIG. 3 are denoted by the same reference numerals as those in FIG. 3, and the description thereof will be omitted. In FIG. 4, illustration of S302 to S310 is omitted for simplification of the drawing. Hereinafter, differences from the processing illustrated in FIG. 3 will be mainly described.

When it is determined in S314 that the question difficulty level received in S312 is a high evaluation result, in S400, the CPU 101 issues a command to the response apparatus to send voice information or image information including a question asking the user whether he/she feels difficult to input a question and is in trouble to the user terminal. As a result, a voice or an image including the question is output via a display or the like of the user terminal. In S402, the CPU 101 determines whether there is an answer that the user is in trouble. When the voice information or the image information including the answer indicating that the user is in trouble is received from the user terminal, an affirmative determination is made in S402, and the CPU 101 issues a command to the response apparatus to make a proposal for switching to the response by the manned operator in the user terminal in S404. Specifically, the CPU 101 sends a message (voice information, character information, and image information) including a proposal for switching to the response by the manned operator to the user terminal. As a result, a voice or an image indicating the content of the proposal is output via a display or the like of the user terminal. Note that the proposal for switching to the response by the manned operator is based on the premise that the user is not currently interacting with the manned operator.

In S406, the CPU 101 determines whether the user desires to switch to the response by the manned operator, and when this determination is affirmative, performs processing of switching to the response by the manned operator in S408. Specifically, the CPU 101 connects the in-vehicle terminal 500B or the chatbot user terminal 500C currently operated by the user to the operator terminal 10, and issues a switching instruction to the operator terminal 10. The operator operating the operator terminal 10 starts user correspondence by text chat or voice in response to the switching instruction. At this time, the CPU can send, to the operator terminal 10, information regarding the background of the responsible answers that have been so far performed between the user terminal and the response apparatus.

After S408, when the responsible answer performed between the user and the manned operator is completed, the dialog response management processing is terminated. Then, the processing illustrated in FIG. 4 can be repeatedly performed until the dialog session is closed.

In a case where the determination in S402 is negative or the determination in S406 is negative, the process proceeds to S410, and search processing corresponding to a case where the evaluation result of the question difficulty level is high is performed. Subsequently, the processes of S322 and S324 described with reference to FIG. 3 are performed. Note that, even if the user does not recognize that the user is in trouble at the time of the determination in S402 and S406 or considers that it is unnecessary to switch to the manned operator, there is a possibility that the user who has seen the answer information sent in S324 changes his/her mind. Therefore, when the answer information is sent to the user terminal in S324, a message including an inquiry of “Are you in trouble?” may be output to the user terminal together with the answer information, and an answer to the inquiry from the user may be waited for. For example, the user can perform an input operation of affirming the question “Are you in trouble?”. In this case, the CPU 101 may execute the process in and after S404 in response to the input operation.

According to the above dialog response management processing described with reference to FIG. 4, when a situation in which the user in the dialog session is in trouble because the user cannot issue a question as intended is detected, it is possible to propose switching to manned operator handling. Then, if the user desires, the user can receive support from a manned operator without going through a complicated procedure. As a result, it is possible to quickly solve the problem, reduce the frustration of the user who uses the dialog service, and increase the customer satisfaction. In addition, even for a user who does not desire to switch to manned operator handling for some reason, it is possible to respond according to the detected question difficulty level, and it is possible to increase the customer satisfaction.

According to the present embodiment, the following operations and effects are achievable.
(1) The dialog response management apparatus 100 (FIG. 2) manages a response operation of sending answer information corresponding to the question information uttered by the user to the user, and includes a question information input unit 110 that accepts that the user operates the user terminal 500A, 500B, or 500C, creates the question information, and sends the question information from the user terminal 500A, 500B, or 500C, a question difficulty level evaluation unit 120 that analyzes either or both of an input operation procedure of the question information by the user and content of the question information, and evaluates a question difficulty level that is a difficulty level when the user creates the question information, and a response change unit 130 that changes a response to the user according to an evaluation result of the question difficulty level evaluation unit 120.

According to this, it is possible to quickly and thoroughly support a user who cannot ask a question as intended and is confused.
(2) In the dialog response management apparatus (100), in a case where the question difficulty level evaluation unit 120 evaluates the question difficulty level by analyzing an input operation procedure of the user's utterance or the question information by character input, in a case where the user has performed an input operation of the question information by utterance, the question difficulty level evaluation unit evaluates that the question difficulty level is high when the user's hesitation or restatement exceeding a predetermined number of times is detected, or when a time until the question information is fixed exceeds a predetermined time, and in a case where the user has performed an input operation of the question information by character input, the question difficulty level evaluation unit evaluates that the question difficulty level is high when a history of character correction exceeding a predetermined number of times is detected during the user's character input operation, or when a time until the question information is fixed exceeds a predetermined time.

According to this, if the user is worried about how to ask a question in the process of the question input by the user, it is possible to detect the problem and appropriately support the user, and it is possible to reduce the user's frustration and increase the customer satisfaction.
(3) In the dialog response management apparatus 100, in a case where the content of the question information by the user's utterance or character input is analyzed, the question difficulty level evaluation unit 120 determines the similarity between the question information when the question information is input a plurality of times in the same dialog session, and evaluates that the question difficulty level is high when there is question information with high similarity.

According to this, it is possible to appropriately support the user who repeats a question with high similarity without solving the problem by receiving and answering one question.
(4) The dialog response management apparatus 100 is connected to a question accumulation unit 350 (FIG. 2) that stores questions previously asked. When the question difficulty level evaluation unit 120 evaluates that the question difficulty level is high, the response change unit 130 extracts question candidates associated with the question information input by the user from the question accumulation unit 350, presents the question candidates in descending order of relevance to the question information (S316 in FIG. 3), and prompts the user to select the question.

According to this, it is possible to present a question candidate having a high relevance or similarity with the question that the user wants to ask to the user who is confused because the user cannot ask the question as expected. The user does not need to input all the contents of the question that the user wants to ask, and only needs to perform an operation of selecting one of the question candidates to be presented. Furthermore, by presenting question candidates to the user in descending order of similarity or in descending order of relevance to a question that the user intends to ask, the user can easily find a target question.
(5) In the dialog response management apparatus 100, when the question difficulty level evaluation unit 120 evaluates that the question difficulty level is high, the response change unit 130 sends (S320, S322, and S324 in FIG. 4), to the user terminal, a message asking whether the user is in a situation in which the user is in trouble, together with the answer information corresponding to the question information.

According to this, it is possible to appropriately support the user even when the user does not feel that the user is in trouble when the user sends out the question information and thereafter feels that the user is in trouble because the answer information as expected when the user sees the answer information has not been obtained.
(6) In the dialog response management apparatus 100, when the question difficulty level evaluation unit 120 evaluates that the question difficulty level is high, the response change unit 130 sends a message including a proposal for switching to a response by a manned operator to the user terminal (S404 in FIG. 4).

According to this, it is possible to appropriately support the user who cannot ask a question as intended and is confused. In addition, it is possible to appropriately cope with a situation in which the content of the question is urgent and the user cannot properly input the question due to feeling rushed.
(7) A dialog response management program (FIGS. 3 and 4) causes a processor 101 included in a dialog response management apparatus 100 (FIG. 2) that manages a response operation of sending, to a user, answer information corresponding to question information uttered by the user to execute: accepting that the user operates user terminals 500A, 500B, and 500C (FIG. 2), creates the question information, and sends the question information from the user terminals 500A, 500B, and 500C (S300 to S308 in FIG. 3); analyzing either or both of an input operation procedure of the question information by the user and content of the question information, and evaluating a question difficulty level that is a difficulty level when the user creates the question information (S310, S312); and changing a response to the user according to an evaluation result of the question difficulty level (S314 to S324).

According to this, it is possible to quickly and thoroughly support a user who cannot ask a question as intended and is confused.
(8) A dialog system includes a user terminal 500 (FIG. 1) operated by a user, and a dialog response management apparatus 100 that manages a response operation of sending answer information corresponding to question information uttered from the user terminal 500 operated by the user toward the user terminal 500. The dialog response management apparatus 100 includes a question information input unit 110 (FIG. 2) that accepts that the user operates the user terminal 500, creates question information, and sends the question information from the user terminal 500, a question difficulty level evaluation unit 120 that analyzes either or both of an input operation procedure of the question information by the user and a content of the question information, and evaluates a question difficulty level that is a difficulty level when the user creates the question information, and a response change unit 130 that changes a response to the user according to an evaluation result of the question difficulty level evaluation unit.

According to this, it is possible to provide a dialog system capable of quickly and thoroughly supporting a user who cannot ask a question as intended and is confused.
(9) In the dialog system, the user terminal 500 includes fixed or portable terminal devices 500A and 500C (FIG. 2) capable of performing communication by at least one of a voice call and a text, and an in-vehicle mobile communication terminal device 500B capable of performing communication by at least one of a voice call and a character, and the dialog response management apparatus 100 is connected to the terminal devices 500A, 500B, and 500C in any form so as to be able to make a response.

According to this, while the user who operates the user terminal receives the dialog service, it is possible to switch from the communication using the text to the communication using the manned voice.

The above embodiment can be combined as desired with one or more of the aforesaid modifications. The modifications can also be combined with one another.

According to the present disclosure, when a user tries to ask a question by interacting with an operator by voice or text or using an unattended dialog system, the user cannot ask an intended question, and when the user is confused, it becomes possible to provide careful support to the user.

Above, while the present invention has been described with reference to the preferred embodiments thereof, it will be understood, by those skilled in the art, that various changes and modifications may be made thereto without departing from the scope of the appended claims.

What is claimed is:

1. A dialog response management apparatus configured to manage a response operation of sending answer information corresponding to question information issued from a user to the user, comprising:
a microprocessor; and
a memory connected to the microprocessor, wherein
the microprocessor is configured to perform:
receiving input of the question information created at a user terminal based on operation by the user and sent from the user terminal;
analyzing either or both of an input operation process of the question information by the user and content of the question information;
evaluating a question difficulty level, the question difficulty level being a degree of difficulty when the user creates the question information; and
changing a response to the user according to a result of the evaluating.

2. The dialog response management apparatus according to claim 1, wherein
the microprocessor is configured to perform:
the evaluating including, when analyzing the input operation process of the question information by speech or text input of the user to evaluate the question difficulty level, in a case where the user performs the input operation of the question information by speech, evaluating the question difficulty level as high when hesitation or rephrasing by the user exceeding a predetermined number of times is detected, or when time until the question information is confirmed exceeds a predetermined time; and
when the user performs the input operation of the question information by text input, evaluating the question difficulty level as high when a history of character corrections exceeding a predetermined number of times is detected during the text input by the user, or when time until the question information is confirmed exceeds a predetermined time.

3. The dialog response management apparatus according to claim 2, wherein
the microprocessor is configured to perform:
the evaluating, when analyzing content of the question information by speech or text input of the user, determining similarity between the question information when the question information is input multiple times during the same dialog session, and evaluating the question difficulty level as high when question information with high similarity exists.

4. The dialog response management apparatus according to claim 1, wherein
the memory is connected to a database to store previously asked questions, and
the microprocessor is configured to perform:
the changing including, when the question difficulty level is evaluated as high in the evaluating, extracting question candidates related to the question information input by the user from the database, presenting the question candidates in order of high relevance to the question information, and prompting selection by the user.

5. The dialog response management apparatus according to claim 1, wherein
the microprocessor is configured to perform:
the changing including, when the question difficulty level is evaluated as high in the evaluating, sending answer information corresponding to the question information together with a message asking whether the user is in a troubled situation toward the user terminal.

6. The dialog response management apparatus according to claim 1, wherein
the microprocessor is configured to perform:
the changing including, when the question difficulty level is evaluated as high in the evaluating, sending a message including a proposal to switch to handling by a manned operator to the user terminal.

7. A computer-readable storage medium storing a dialog response management program for causing a computer comprising a processor and a memory to execute, wherein
the dialog response management program causes the computer to perform:
receiving input of question information created at a user terminal based on operation by a user and sent from the user terminal,
analyzing either or both of an input operation process of the question information by the user and content of the question information,
evaluating a question difficulty level, the question difficulty level being a degree of difficulty when the user creates the question information, and
changing a response to the user according to a result of the evaluating.

8. A dialog system comprising:
a user terminal operated by a user; and
a dialog response management apparatus configured to manage a response operation of sending answer information corresponding to question information issued from the user terminal toward the user terminal, wherein
the dialog response management apparatus comprises a microprocessor and a memory connected to the microprocessor, and
the microprocessor is configured to perform:
receiving input of the question information created at the user terminal based on operation by the user and sent from the user terminal;
analyzing either or both of an input operation process of the question information by the user and content of the question information;
evaluating a question difficulty level that is a degree of difficulty when the user creates the question information; and
changing a response to the user according to a result of the evaluating.

9. The dialog system according to claim 8, wherein
the user terminal includes a fixed or portable terminal device capable of communication by at least one of a voice call and a text, and an in-vehicle mobile communication terminal device capable of communication by at least one of voice call and text.
